(19) United States
(12) Patent Application Publication
(10) Pub. No.: US 2021/0292480 A1
(43) Pub. Date: Sep. 23, 2021

(54) POLYIMIDE MATERIAL AND PREPARATION METHOD THEREOF, ELECTROCHROMIC DEVICE

(71) Applicant: WUHAN CHINA STAR OPTOELECTRONICS SEMICONDUCTOR DISPLAY TECHNOLOGY CO., LTD., Wuhan (CN)

(72) Inventor: Yamin WANG, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/497,445

(22) PCT Filed: Jun. 12, 2019
(86) PCT No.: PCT/CN2019/090931

§ 371 Date: Jun. 15, 2021

(30) Foreign Application Priority Data
May 27, 2019 (CN) 201910443844.6

(51) Int. Cl. C08G 73/10; G02F 1/1516

(52) U.S. Cl. CPC C08G 73/1071; G02F 1/15165; C08G 73/1007

(57) ABSTRACT

The present invention discloses a polyimide material, a preparation method thereof, and an electrochromic device, wherein the polyimide material has a polyhedral oligomeric silsesquioxane (POSS) as an end capping group. The present invention has the beneficial effects that the polyimide material, the preparation method thereof, and the electrochromic device of the present invention use an oligoaniline and a fluorescent triphenylamine fragments as raw materials to prepare a polyamic acid solution, and then introducing the polyhedral oligomeric silsesquioxane (POSS) as the end capping group of the polyimide material to give an electrochromic ability and stable electroluminescence to the polyimide material, which provides directional guidance for subsequent fluorescent displays and electrochromic devices.

### BACKGROUND OF INVENTION

### Field of Invention

The present invention relates to a field of electroluminescent, in particular to a polyimide material, a preparation method thereof, and an electrochromic device.

### Description of Prior Art

Electroluminescent materials can be roughly classified into three types: first: those containing molecular binary, second: those intrinsically containing a switchable fluorophore, and third: those forming a switchable fluorescent polymer. Electrochromic polymers are very popular due to their rapid transition, simple molecular design, and good processability. Among the electrochromic polymers, polyaniline has been extensively studied for its ease of synthesis, high electroactivity, and reversible acid-base doping/de-doping. However, polyaniline-based electrochromic devices are still rare, mainly due to their limited solubility and poor processability. Therefore, there is an urgent need for new strategies to improve their solubility and processability.

### SUMMARY OF INVENTION

The present invention provides a polyimide material, a preparation method thereof, and an electrochromic device, for solving the problems of poor solubility and processability of the polyaniline-based electrochromic device in the prior art.

A technical solution to solve the above problems is that the present invention provides a polyimide material having a polyhedral oligomeric silsesquioxane (POSS) as an end capping group.

Further, the polyimide material includes polyimide having a molecular structural formula as follow:

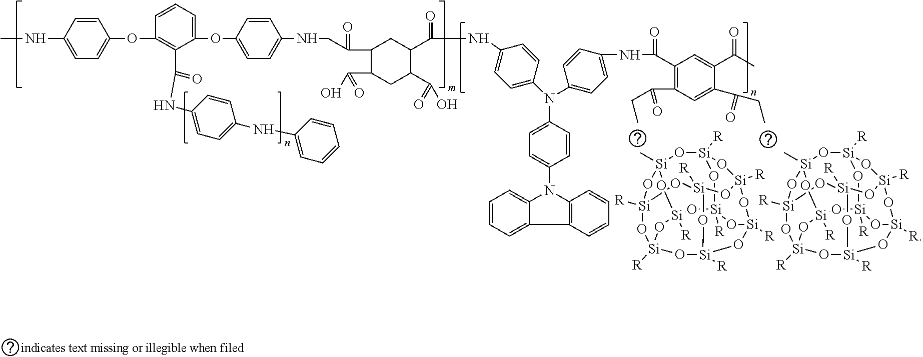

The present invention also provides a method of preparing a polyimide material, which includes the following steps: providing a carboxyl-terminated polyamic acid; dissolving the carboxyl-terminated polyamic acid in N,N′-dimethylacetamide to obtain a first solution; adding polyhedral oligomeric silsesquioxane to the first solution, for carrying out a polymerization reaction for 5 to 8 hours at a temperature of 110° C., and after the polymerization reaction is completed, the first solution is cooled to room temperature to obtain a polyimide solution including the polyhedral oligomeric silsesquioxane as an end capping group; stirring the polyimide solution for 3 to 5 hours, removing foam, and spin-coating the polyimide solution on a glass substrate; and baking the glass substrate in an oven to obtain a polyimide material including the polyhedral oligomeric silsesquioxane as the end capping group.

Further, the polyhedral oligomeric silsesquioxane (POSS) is selected form at least one of the following structural formulas:

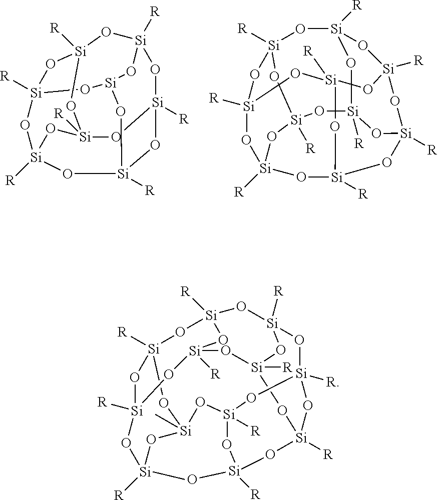

Further, the step of providing the carboxyl-terminated polyamic acid includes: mixing 1,2,4,5-cyclohexanetetracarboxylic dianhydride with an electroactive diamine monomer; adding 4,40-diamino-400-Noxazolyl triphenylamine and dimethylacetamide to a 50 mL three-neck round bottom flask under an argon atmosphere; carrying out a copolymerization reaction under magnetic stirring at room temperature for 24 to 96 hours to obtain a polyamic acid solution; pouring the obtained polyamic acid solution into 100 mL to 500 mL of methanol under stirring to produce a gray precipitate; and washing the precipitate, followed by drying under vacuum to obtain the carboxyl-terminated polyamic acid.

Further, the precipitate is washed by water and methanol; and a temperature of drying under vacuum ranges from 300° C. to 475° C.

Further, the carboxyl-terminated polyamic acid has the following structural formula:

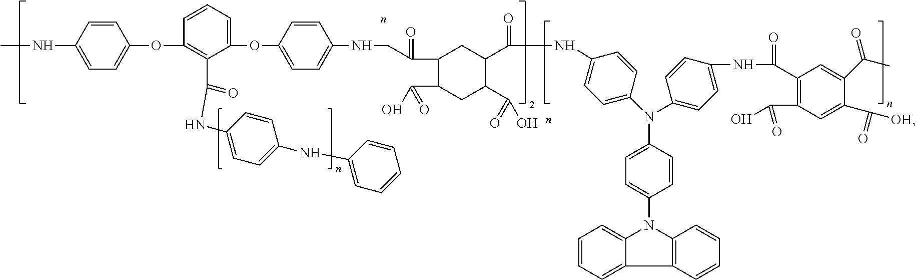

and

the polyhedral oligomeric silsesquioxane has the following structural formula:

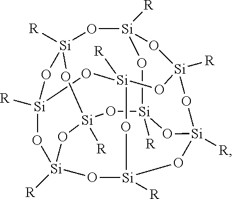

and

the polyimide has the following structural formula:

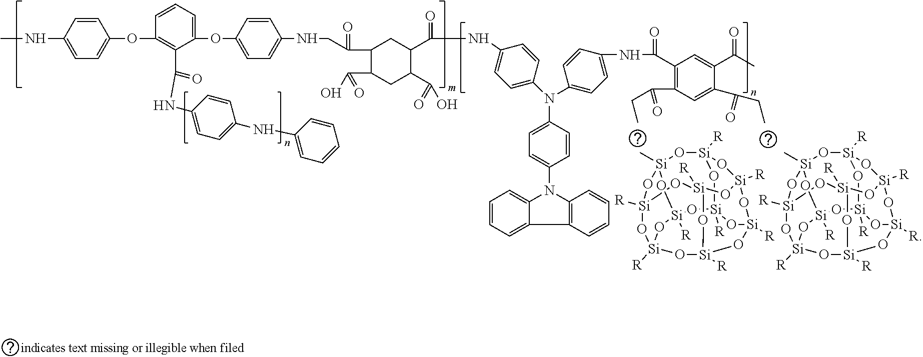

The present invention also provides an electrochromic device including the polyimide material.
Further, the electrochromic device includes an electrochromic layer having the polyimide material as an electroluminescent material.
Further, the electrochromic layer is an anode electrochromic layer or a cathodic electrochromic layer.

The present invention has the advantages that the polyimide material, the preparation method thereof, and the electrochromic device of the present invention use an oligoaniline and a fluorescent triphenylamine fragments as raw materials to prepare a polyamic acid solution, and then introduce the polyhedral oligomeric silsesquioxane (POSS) as the end capping group of the polyimide material to give an electrochromic ability and stable electroluminescence to the polyimide material, which provides directional guidance for subsequent fluorescent displays and electrochromic devices.

### BRIEF DESCRIPTION OF DRAWINGS

The present invention is further explained below in conjunction with the drawings and embodiments.

FIG. 1 is a cyclic voltammogram of a carboxyl-terminated polyamic acid and a polyimide material including polyhedral oligomeric silsesquioxane (POSS) as an end capping group in a CH₃CN solution.

FIG. 2 is a fluorescence spectrum of a N,N′-dimethylacetamide solution using a carboxyl-terminated polyamic acid with a quantitative ammonium persulfate oxidized compound and a polyimide material including oligomer polyhedral oligomeric silsesquioxane (POSS) as an end capping group.

FIG. 3 is a specific process condition 1 for using an oven.

FIG. 4 is a specific process condition 2 for using an oven.

FIG. 5 is a specific process condition 3 for using an oven.

FIG. 6 is a specific process condition for using an oven.

### DETAILED DESCRIPTION OF PREFERRED EMBODIMENTS

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references. The spatially relative terms are intended to encompass different orientations in addition to the orientation as depicted in the figures.

Embodiment

In this embodiment, the polyimide material of the present invention is a compound including polyhedral oligomeric silsesquioxane (POSS) as an end capping group, which forms a bulk side group to impart stable electroluminescence to the polyimide material.

The oligomeric polyhedral oligomeric silsesquioxane (POSS) is an inorganic-organic three-dimensional hybrid material having a structure between silica and polysiloxane and is a novel additive that can be used for reaction and doping. The POSS is selected from at least one of the following structural formulas:

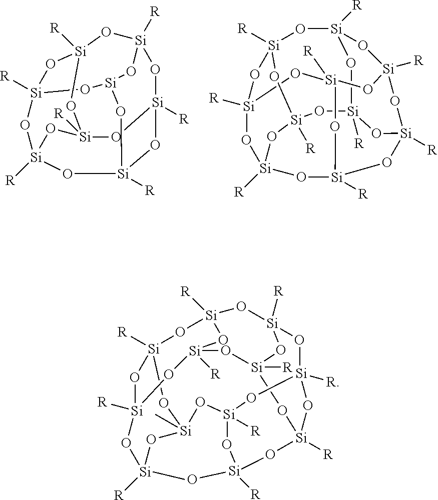

In an embodiment of the present invention, the polyimide material includes polyimide having a molecular structural formula as follow:

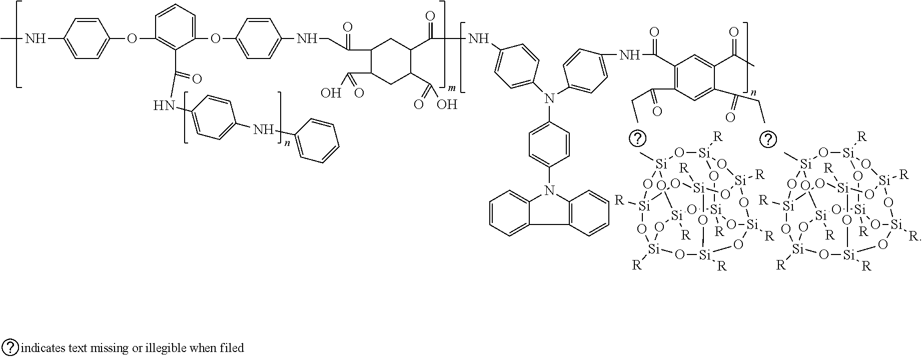

In order to explain the present invention more clearly, the polyimide material is further explained below in connection with the method of preparing the polyimide material of the present invention.

The specific method of preparing the polyimide material includes the following steps.

The dried precipitated carboxyl-terminated polyimic acid was dissolved in 8 mL to 12 mL of N,N′-dimethylacetamide to obtain a first solution, wherein the carboxyl-terminated polyamic acid has the following structural formula:

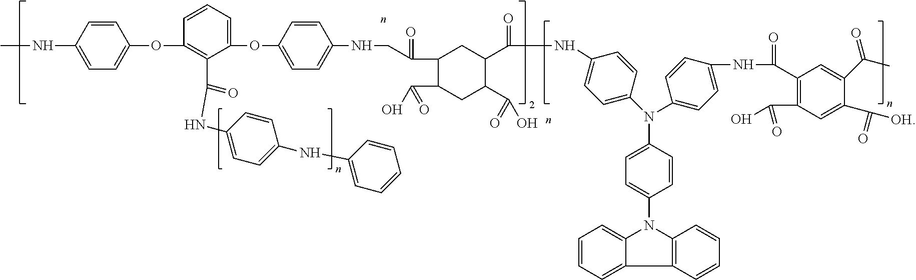

The dried precipitated carboxyl-terminated polyimic acid was dissolved in 8 mL to 12 mL of N,N′-dimethylacetamide to obtain a first solution, wherein the carboxyl-terminated polyamic acid has the following structural formula:

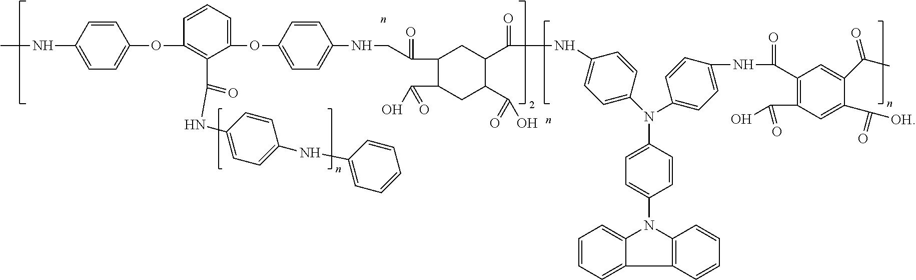

The specific preparation method includes the following steps:

0.1 mmol to 1.3 mmol of 1,2,4,5-cyclohexanetetracarboxylic dianhydride was mixed with 0.1 mmol to 1.2 mmol of electroactive diamine monomer.

4,40-diamino-400-N-carbazolyltriphenylamine and dimethylacetamide were added to a 50 mL three-neck round bottom flask under argon atmosphere, wherein the dimethylacetamide was obtained from a commercial source and can be used directly without purification.

A copolymerization reaction under magnetic stirring at room temperature for 24 to 96 hours to obtain a polyamic acid solution.

The obtained polyamic acid solution was poured into 100 mL to 500 mL of methanol under stirring to obtain a gray precipitate.

The precipitate was thoroughly washed with water and methanol to remove impurities, and then vacuum dried at 300 to 475° C. to obtain a carboxyl-terminated polyamic acid.

0.1 mmol to 1.2 mmol of oligomeric polyhedral oligomeric silsesquioxane (POS S) were added to the first solution for carrying out a polymerization reaction for 5 to 8 hours at a temperature of 110° C., followed by cooling to room temperature to obtain a second solution. In this example, the polyhedral oligomeric silsesquioxane has the following structural formula:

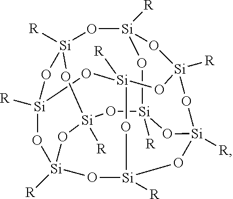

The second solution was stirred for 3 to 5 hours. After removing foam, the second solution was spin-coated on a glass substrate.

The glass substrate was baked in an oven to obtain a polyimide material including the polyhedral oligomeric silsesquioxane as the end capping group.

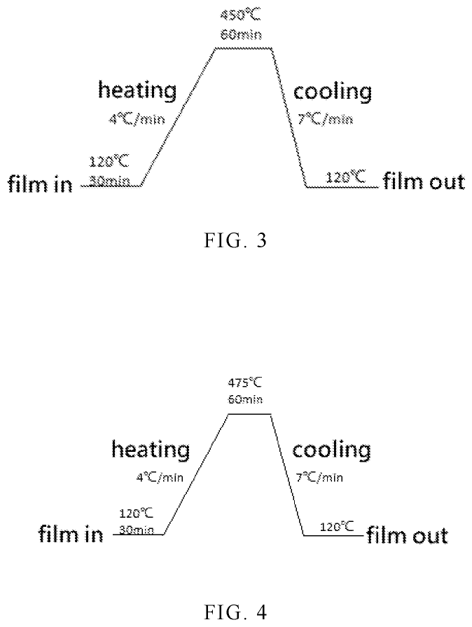

The process conditions of polyimide material including the polyhedral oligomeric silsesquioxane as the end capping group were shown in FIGS. 3 to 6.

The polyimide material including the polyhedral oligomeric silsesquioxane as the end capping group was formed in the oven by the specific process conditions (FIGS. 3 to 6). In particular, the process for forming the polyimide material including the polyhedral oligomeric silsesquioxane as the end capping group was continued for 3-5 hrs with a heating rate of 4-10° C./min, and the highest temperature was 420° C.-500° C. The baking stage was divided into hard baking and soft baking. The hard baking was directly heating to the highest temperature, keeping the temperature unchanged for about 1 hr, and then cooling down. The soft baking was a constant temperature platform with 2 or more times, and finally cooling down. Such that, cross-linking and solvent removal of the material at different constant temperature stages can be realized. The method used in this present invention includes but not limited to the above-described baking methods and time intervals.

FIG. 3 is a graph showing changes in temperature of a glass substrate on which the polyimide material solution was spin-coated during the first baking. The polyimide material including the polyhedral oligomeric silsesquioxane (POSS) as the end capping group was baked in the oven at a starting temperature of 120° C. and kept at a constant temperature for 30 min, then raised at a rate of 4° C./min to a maximum temperature of 450° C. and kept for 60 min, and then cooled at a rate of 4° C./min to a temperature of to 120° C.

FIG. 4 is a graph showing changes in temperature of a glass substrate on which the polyimide material solution was spin-coated during the second baking. The polyimide material including the polyhedral oligomeric silsesquioxane (POSS) as the end capping group was baked in the oven at a starting temperature of 120° C. and kept at a constant temperature for 30 min, then raised at a rate of 4° C./min to a maximum temperature of 450° C. and kept for 60 min, and then cooled at a rate of 4° C./min to a temperature of to 120° C.

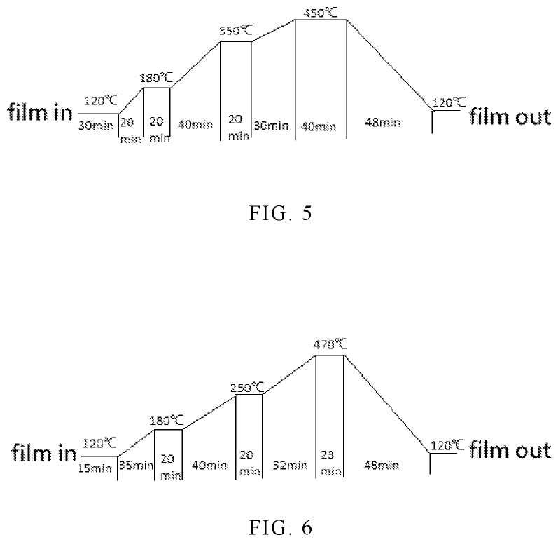

FIG. 5 is a graph showing changes in temperature of a glass substrate on which the polyimide material solution was spin-coated during the third baking. The polyimide material including the polyhedral oligomeric silsesquioxane (POSS) as the end capping group was baked in the oven at a starting temperature of 120° C. and kept at a constant temperature for 30 min, then raised to a temperature of 180° C. in 20 min and kept for 20 min, then raised to a temperature of 450° C. in 30 min and kept for 40 min, and then cooled to a temperature of to 120° C.

FIG. 6 is a graph showing changes in temperature of a glass substrate on which the polyimide material solution was spin-coated during the fourth baking. The polyimide material including the polyhedral oligomeric silsesquioxane (POSS) as the end capping group was baked in the oven at a starting temperature of 120° C. and kept at a constant temperature for 15 min, then raised to a temperature of 180° C. in 35 min and kept for 20 min, then raised to a temperature of 250° C. in 40 min and kept for 20 min, then raised to a temperature of 470° C. in 32 min and kept for 23 min, and then cooled to a temperature of to 120° C.

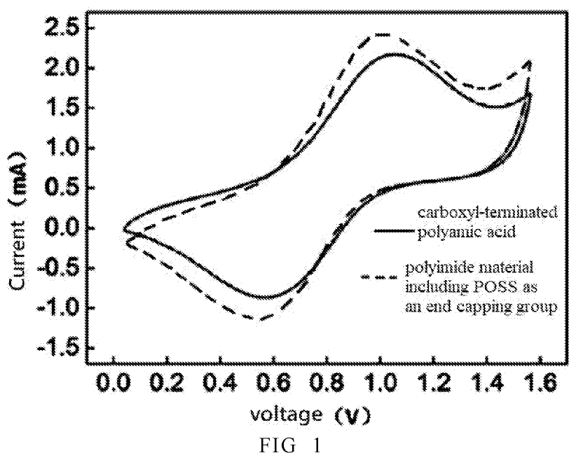

As shown in FIG. 1, FIG. 1 is a cyclic voltammogram of a carboxyl-terminated polyamic acid and a polyimide material including polyhedral oligomeric silsesquioxane (POSS) as an end capping group in a CH₃CN solution at a scanning rate of 100 mV/s⁻¹.

A film spin-coated on an indium tin oxide (ITO) substrate was used as a working electrode in a 0.1 M tetrabutylammonium perchlorate (TBAP) CH₃CN solution. A platinum electrode and an Ag/AgCl electrode were also introduced in the three-electrode setup as a counter electrode and a reference electrode.

The current-voltage (CV) curve of the film of the carboxyl-terminated polyamic acid and the polyimide material including the polyhedral oligomeric silsesquioxane (POSS) as the end capping group shows two pairs of reversible redox peaks, respectively attributed to a reduced state/oxidized state transition (oligoaniline fragments) and a neutral state/radical cationic state transition (nitrogen atoms of triphenylamine fragments). It can be seen that a peak area of the CV curve of the polyimide material including the polyhedral oligomeric silsesquioxane (POSS) as the end capping group introduced was higher than a peak area of the CV curve of the carboxyl-terminated polyamic acid, and it can be seen that the polyimide material including the polyhedral oligomeric silsesquioxane (POSS) as the end capping group has an electrochemical stability superior to the carboxyl-terminated polyamic acid.

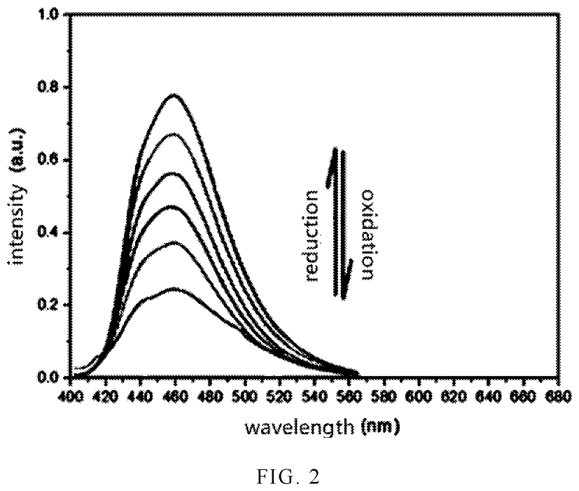

As shown in FIG. 2, FIG. 2 is a fluorescence spectrum of a N,N′-dimethylacetamide solution using a carboxyl-terminated polyamic acid with a quantitative ammonium persulfate oxidized compound and a polyimide material including oligomer polyhedral oligomeric silsesquioxane (POSS) as an end capping group. An emission peak was observed at 462 nm, and the fluorescence intensity reached nearly 80%. After adding a quantitative oxidant (ammonium persulfate), the oxidation reaction was completely finished after 3 h, and the fluorescence intensity eventually decreased to 30% of its original value without a significant change in the peak position. The fluorescence intensity of the carboxyl-terminated polyamic acid solution was restored to its original value by addition of a quantitative reducing agent (benzoquinone). Fluorescence transition characteristics of this redox species can be attributed to a fluorescence quenching effect of quinoline rings in the oligoaniline fragments. An oxidant produces more anthracene rings in the oligoaniline segments, which will quench a portion of fluorescence between carbazole and oligoaniline by energy transfer that occurs. A reverse process may also occur when the carboxyl-terminated polyamic acid solution was reduced from an oxidized state to a reduced state. The polyimide material including the polyhedral oligomeric silsesquioxane (POSS) as the end capping group also had properties similar to the carboxyl-terminated polyamic acid, indicating that the introduced oligomeric polyhedral oligomeric silsesquioxane (PO

In this example, oligoaniline and a fluorescent triphenylamine fragments were used as raw materials to prepare a polyamic acid solution, and then the polyhedral oligomeric silsesquioxane (POSS) was introducing to the polyimide material as the end capping group to give an electrochromic ability and stable electroluminescence to the polyimide material.

The electroluminescent material of the present invention uses the polyimide material as a light-emitting material, and as materials for an anode electrochromic layer and the cathode electrochromic layer of the electrochromic material electrochromic device, wherein the electrochromic device further includes a substrate; a transparent electrode layer disposed on a surface of the substrate, a metal conductive layer disposed on a side of the transparent electrode layer facing or facing away from the substrate; and the anode electrochromic layer located on a side of the transparent electrode layer facing away from the substrate; an ion conductive layer on a side of the anode electrochromic layer facing away from the substrate; the cathode electrochromic layer on a side of the ion conductive layer facing away from the substrate. The main technical features and technical effects of the electrochromic device are embodied on the electrochromic layer.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A polyimide material, comprising polyhedral oligomeric silsesquioxane (POSS) as an end capping group.

2. The polyimide material according to claim 1, comprising polyimide having a molecular structural formula as follow:

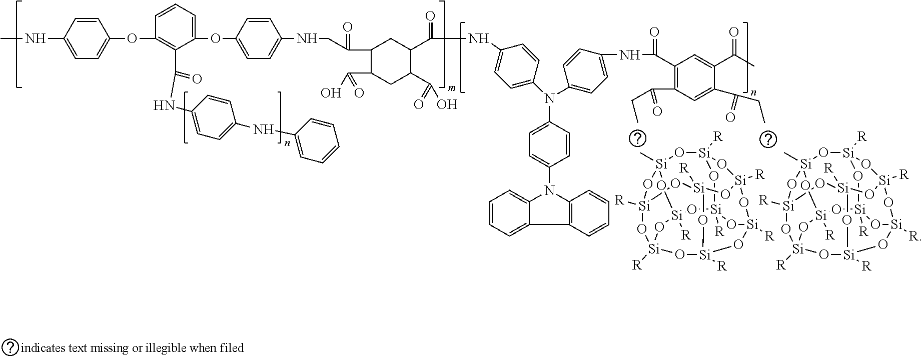

3. A method of preparing a polyimide material, comprising the following steps:
providing a carboxyl-terminated polyamic acid;
dissolving the carboxyl-terminated polyamic acid in N,N′-dimethylacetamide to obtain a first solution;
adding polyhedral oligomeric silsesquioxane to the first solution, for carrying out a polymerization reaction for 5 to 8 hours at a temperature of 110° C., and after the polymerization reaction is completed, the first solution is cooled to room temperature to obtain a polyimide solution comprising the polyhedral oligomeric silsesquioxane as an end capping group;
stirring the polyimide solution for 3 to 5 hours, removing foam, and spin-coating the polyimide solution on a glass substrate; and
baking the glass substrate in an oven to obtain a polyimide material comprising the polyhedral oligomeric silsesquioxane as the end capping group.

4. The method of preparing the polyimide material according to claim 3, wherein the polyhedral oligomeric silsesquioxane is selected form at least one of the following structural formulas:

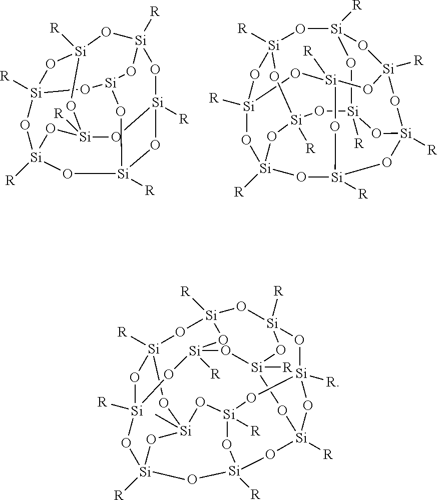

5. The method of preparing the polyimide material according to claim 3, wherein the step of providing the carboxyl-terminated polyamic acid comprises:
mixing 1,2,4,5-cyclohexanetetracarboxylic dianhydride with an electroactive diamine monomer;
adding 4,40-diamino-400-Noxazolyl triphenylamine and dimethylacetamide to a 50 mL three-neck round bottom flask under an argon atmosphere;
carrying out a copolymerization reaction under magnetic stirring at room temperature for 24 to 96 hours to obtain a polyamic acid solution;
pouring the obtained polyamic acid solution into 100 mL to 500 mL of methanol under stirring to produce a gray precipitate; and
washing the precipitate, followed by drying under vacuum to give the carboxyl-terminated polyamic acid.

6. The method of preparing the polyimide material according to claim 5, wherein the precipitate is washed by water and methanol.

7. The method of preparing the polyimide material according to claim 3, wherein the carboxyl-terminated polyamic acid has the following structural formula: 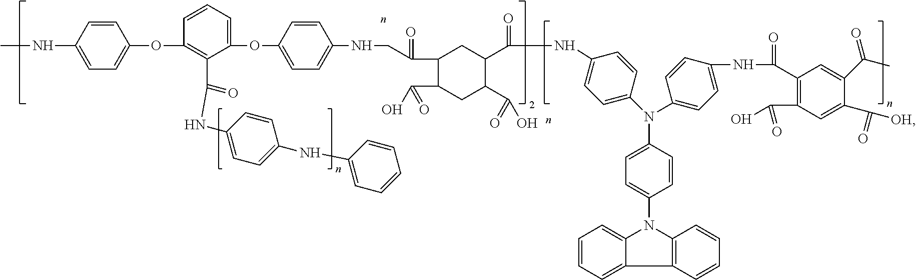
and
the polyhedral oligomeric silsesquioxane has the following structural formula: 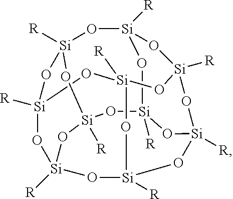
and
the polyimide has the following structural formula:

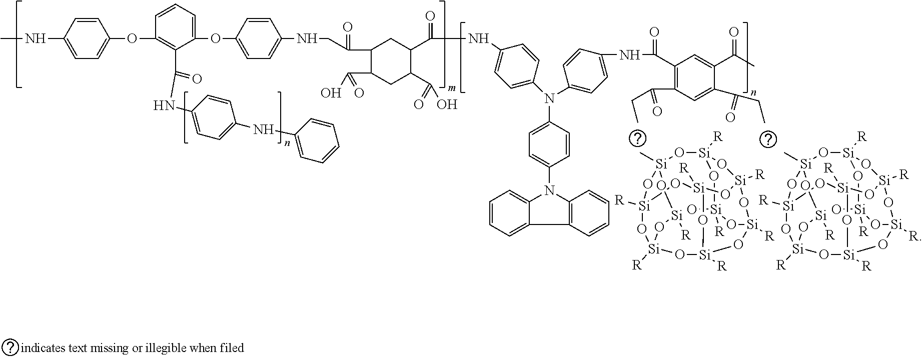

8. An electrochromic device comprising the polyimide material of claim 1.

9. The electrochromic device according to claim 8, comprising an electrochromic layer having the polyimide material as an electroluminescent material.

10. The electrochromic device according to claim 9, wherein the electrochromic layer is an anode electrochromic layer or a cathodic electrochromic layer.
